(19) United States
(12) Patent Application Publication
(10) Pub. No.: US 2004/0131005 A1
(43) Pub. Date: Jul. 8, 2004

(54) Multilayer optical data store medium

(76) Inventor: Luigi Carabiniere, Milan (IT)

Correspondence Address: YOUNG & THOMPSON, 745 SOUTH 23RD STREET 2ND FLOOR, ARLINGTON, VA, 22202

(21) Appl. No.: 10/474,454

(22) PCT Filed: Sep. 24, 2001
(86) PCT No.: PCT/IT01/00486

(30) Foreign Application Priority Data
Apr. 20, 2001 (IT) RM2001A000217

(51) Int. Cl. G11B 7/24

(52) U.S. Cl. 369/275.3; 369/283

(57) ABSTRACT

The invention concerns a multilayer optical data storage medium comprising a first layer and a second overturned layer, said first and second layers being coupled each other by the interposition of an optically neutral coupling layer, said first and second layers both defining a focal reading plane, readable by a standard driving system, the data distribution of the data on the focal plane of said first layer being such to provide a zone lacking the data, to which zone corresponds the presence of data on the focal plane of the second layer, in such a way that the player, loosing the focal plane on the first layer individuates the focus signal on the second layer.

The present invention relates to an improved multilayer optical data storage medium.

More specifically, the invention concerns to an improved double layer optical data storage medium that can be read by the standard CD players, without the need of turning upside the medium to obtain the reading of the second layer.

Still more specifically, the invention concerns a medium of the above kind having a data storage capability greater than the known double layer media.

It must be understood that the solution suggested according to the present invention can be indifferently employed for medium having every regular, or irregular, shape, and having every geometrical shape, for cards having every shape and dimensions, as well as minidiscs or in any case media having a variable radius circumference.

Furthermore, the solution suggested can be applied also to new systems just put on the market (“Purple Book” system manufactured by Sony and Philips), or that will be put on the market in the future, and that can be adapted to the inventive solution without the need of a technical intervention on the same solution.

As it is well known, are presently available on the market two different kind of products, known as DVD-9, allowing the use and the reading of both sides of a Compact Disc (CD).

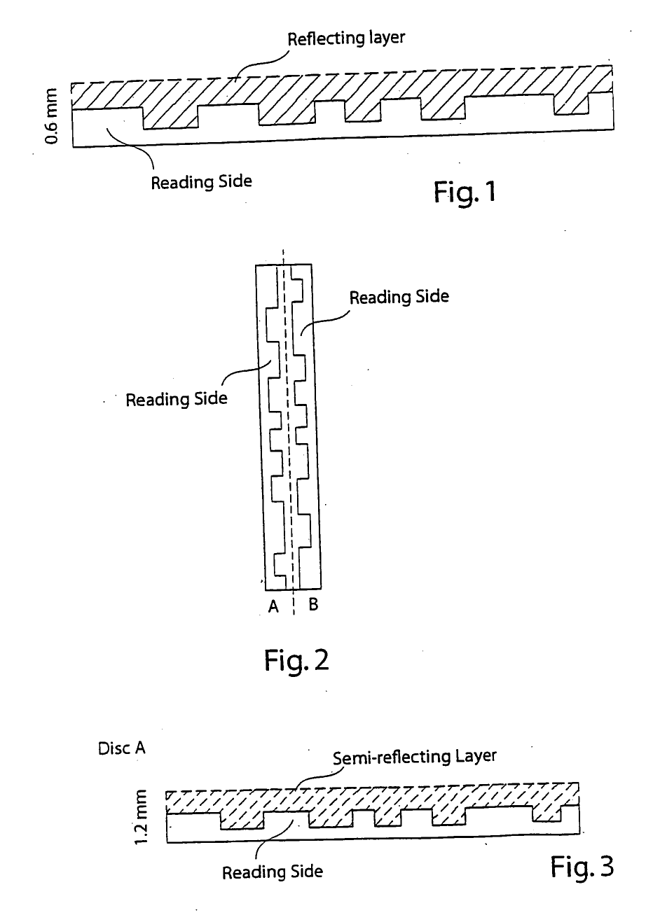

The first typo of optical data support or “media” is known as “DVD-9 Reverse”. It is a CD providing two layers thick 0.6 mm each, as it can be noted from the enclosed FIG. 1, wherein the reading side is opposed, so that, to use the second layer, it is necessary to “turning upside” the disc.

Under the production point of view, the process is based on the creation of two layers, usually obtained by “SON” of the stamper. (CD printing mould that is introduced into the press).

Positioning along the production line occurs intercalating each other the two kinds of sequences discs of the type ABABABABABABAB (see the enclosed FIG. 2). Afterwards, some glue is put on the centre of one of the two discs, putting them in contact in such a way to make the two centres of the same discs coinciding.

Then, the two semi glued discs are rotated and the glue, due to the centrifugal effect, uniformly spreads along the entire surface.

Suction cup effect generated between the discs draws the contact surfaces and glues the same.

This kind of data storage support or “median” has two drawbacks. The first drawback concerns the fact that to access (reading) to the two layers, it is necessary to turn the support. The second drawback is that it is not possible to silk screen the sides of the disc, since both exposed sides are reading sides.

The second kind of data storage support or “media” is known as “DVD-9 No Reverse”.

With respect to the “DVD-9 Reverse”, as indicated in the enclosed FIGS. 3-5, only one reading side is present.

Said data storage support or “media” is realised starting from two discs, but in this case disc B is moulded considering a copy of the “MOTHER” of the “stamper”.

Semi-reflecting layer placed between disc A and disc B allows to the reading player to move the reading focusing plane from layer A to layer B, without the need of turn the disc.

In other words, it is exploited the capability of focal compensation of the lens.

In this case, it is a situation as if the negative of layer B is moulded, and it is considered as the opposite reading layer with respect to the standard case.

Manufacturing line is modified with respect to the previous data storage support or “media” since, as it can be noted from the figures, inverted Land-Pit of disc B are covered by a reflecting substance that allows to read the layer.

The above solution “DVD-9 No Reverse” can be used only for CD of the DVD type. It is not known in the art a “No Reverse” double layer CD, nor a solution allowing the “No Reverse” reading.

A mechanism is implemented in DVD, able to select the focal reading plane by a declaration of the so-called TOC (“Table of Contents”). Reading occurs on the first layer according a clockwise direction, and on the second layer according to an anticlockwise direction.

Consequently, a CD simply comprised of two coupled layers, not using any particular mechanism to realise and reading the two layers, would be read on the first layer exactly as on the second layer, according to a clockwise direction (PTP), thus reading the track on the second layer from its end.

In view of the above, and on the basis of the consideration of the fact that also the optical groups of the CD players have the capability of compensating the focal reading plane, the Applicant has individuated that it is possible to create a support or CD, the manufacturing technique of which is similar to the one already described in the preceding with reference to the “DVD-9 No Reverse”, but with a different production technique of the second layer.

By the solution according to the invention, and exploiting also the teachings of the Italian Patent Application No RM98A000803, filed on Dec. 28, 1998, it is possible to create a support the capability of which is doubled, always remaining compatible with the standard CD and DVD players.

It is therefore specific object of the present invention a multilayer optical data storage medium comprising a first layer and a second overturned layer, said first and second layers being coupled each other by the interposition of an optically neutral coupling layer, said first and second layers both defining a focal reading plane, readable by a standard driving system, the data distribution of the data on the focal plane of said first layer being such to provide a zone lacking the data, to which zone corresponds the presence of data on the focal plane of the second layer, in such a way that the player, loosing the focal plane on the first layer individuates the focus signal on the second layer.

According to the invention, said first layer can be substantially comprised of a standard CD.

Furthermore, according to the invention, said first layer can be substantially comprised of a DVD-9 “No Reverse”.

Still according to invention, said first layer can be substantially comprised of a Super Audio CD (SACD).

According to the invention, said second layer has a reduced thickness with respect to said first layer.

The multilayer optical data storage medium according to the present invention is characterised by the fact of being Readable or Writable on both layers comprising the medium, or it is Readable on one side and Writable on the other side.

Furthermore, according to the invention, data on said second layer are printed on a “SON” deriving from the “MOTHER”.

Further, according to the invention, said optically neutral coupling layer is comprised of an optically neutral glue layer;

Always according to the invention, said second layer is obtained by a standard master, the first 12 bytes of the data blocks of which are modified inserting the running time (duration, in seconds, of a movie or of an audio excerpt) of the last valid data block of the first layer as offset (translation value).

Furthermore, said first layer is obtained by a master containing a lead-in, wherein the end of the data track is indicated starting from a distance different with respect to where it really ends, particularly an indication of 59 mm.

Still according to the invention, the stamper for the second layer is realised employing a negative stamper of the “SON”, i.e. the negative of the “FATHER”.

Preferably, in the solution according to the present invention, the first layer provides a semi-reflecting silicone layer.

Further, said second layer provides a metalisation layer comprised of an aluminium layer.

In a preferred embodiment of the medium according to the invention, the metalisation on said first layer is interrupted in a point anticipated with respect to what is declared in the lead-in.

Still according to the invention, it is possible to provide one or more chips and/or one or more magnetic strips, and/or contactless reading systems on the upper layer.

The present invention will be now described, for illustrative but not limitative purposes, according to its preferred embodiments, with particular reference to the figures of the enclosed drawings, wherein:

FIG. 1 is a section view of a layer of a multilayer optical data storage support or “medium” DVD-9 Reverse according to the prior art;

FIG. 2 is a section view of a multilayer optical data storage support or “medium” DVD-9 Reverse according to the prior art;

FIG. 3 is a section view of a first layer of a multilayer optical data storage support or “medium” DVD-9 No Reverse according to the prior art;

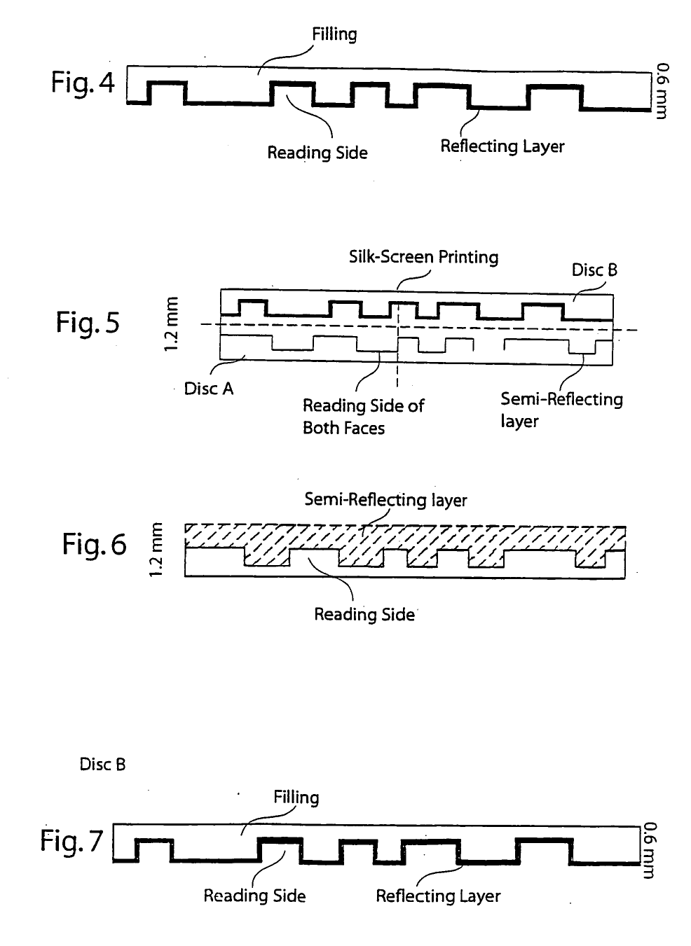

FIG. 4 is a section view of a second layer of a multilayer optical data storage support or “medium” DVD-9 No Reverse according to the prior art;

FIG. 5 is a section view of a multilayer optical data storage support or “medium” DVD-No 9 Reverse according to the prior art;

FIG. 6 is a section view of a first layer of a multilayer optical data storage support or “medium” according to the invention;

FIG. 7 is a section view of a second layer of a multilayer optical data storage support or “medium” according to the invention;

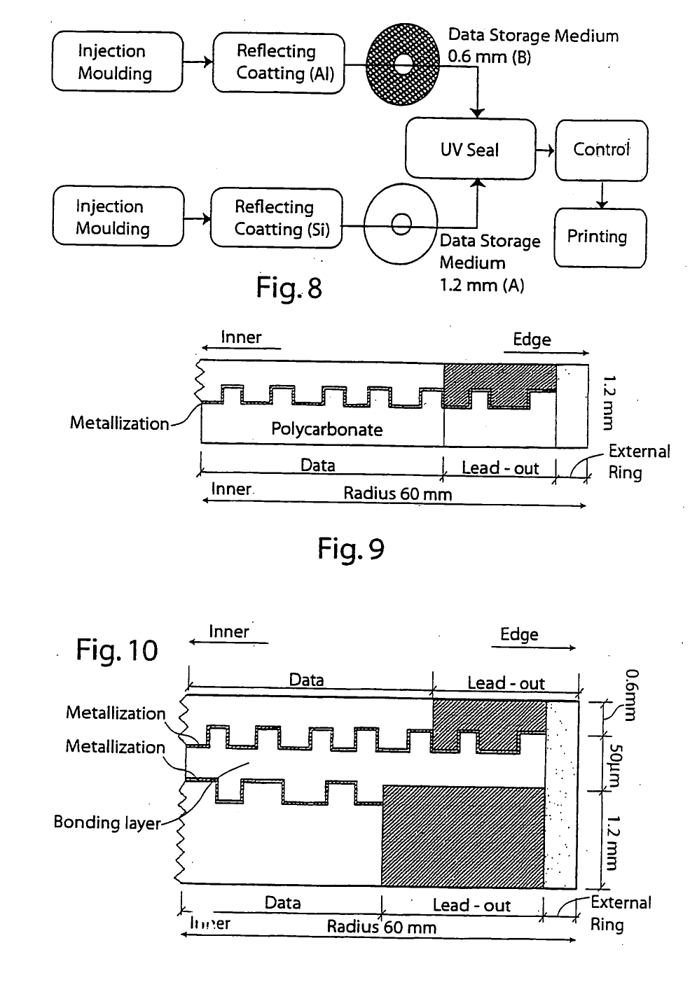

FIG. 8 is a block diagram of a gluing system for a multilayer optical data storage support or “medium” according to the invention;

FIG. 9 is a section view of a standard CD; and

FIG. 10 is a section view of the multilayer optical data storage support or “medium” as modified according to the invention.

Some symbols and nomenclature will be used in the specification of the solution suggested according to the present invention, said symbols and nomenclature being listed in the following for a better comprehension of the same specification.

In the following:

Layer A: it is meant the data layer at a distance of 1-1.4 mm from the reading pick-up (i.e. the part of the CD/DVD players providing the laser gun) for standard CD and at a distance of 0.5-0.6 mm from said pick-up in case of DVD or SACD. In the solution according to the present invention, it is physically represented by a standard CD, except for the metalisation layer.

Layer B: it is physically represented by a reduced thickness standard CD (thickness 0.4-0.6 mm), on which data are not printed, as it usually occurs, on a “SON” deriving from the “FATHER”. On the contrary, in this case, data are printed on a “SON” deriving from the “MOTHER” of the stamper. When the two layers are coupled, the layer on which the data are stored is at a distance of about 1.3 mm from the reading pick-up of the CD player.

Bonding Layer: it is a glue layer which is optically neutral with respect to the wavelength of the reading laser, even if said layer is sensitive to the UV rays, and is employed to couple the two A and B data layers.

In the multilayer optical data storage medium according to the invention, layers A and B can have every shape, both having the same shape or having different shapes.

Further, layer A can be essentially comprised of a standard CD, or of a DVD-9 “No Reverse”, or of a SACD, the total thickness of which (Layer A+Layer B) being of about 1.8 mm, the “medium” thus obtained being still readable by the standard (CD or DVD) players.

Storage capability of the multilayer optical data storage medium according to the present invention, in case layer A is comprised of a DVD-9 No Reverse, would arrive at about 13.5 Gbytes.

It must be pointed out that, in line of principle, the teachings according to the present invention can be also used to realise and optical medium comprised of a number of layers higher than 2, being understood that in any case the final thickness must be that indicated in the above, to allow its reading by standard players.

It is known that data, in a binary digital format, are physically stored on the CD along a spiral-shaped track running all along the disc surface.

At the end of the recording, spiral-shaped track of a writable/re-writable CD has the same logical structure of an Only Read CD, or CDROM, providing, as an international normalisation, or standard, that the track is divided into different sections. Each one of the sections of the track has specific information and can be individuated as a circular crown area on the optically active surface of the disc.

According to the “Red Book” standard, CDROM structure (comprising every kind of information), is comprised of the following parts:

Lead In track: it contains coded information indicating to the player information and kind of the following data tracks.

PMA area: it is the area containing the User data.

Lead Out track: this information is meaningful for multi-session discs, i.e. all the discs wherein the data are added in subsequent times. It is evident that the above is meaningful only for recordable/re-writable supports, since CDROM is industrially manufactured and it is not possible to add data on the same. In the CDROM production techniques, Lead Out track is present only for a simpler operation of the player. Only recently it has been thought to reduce its length from 90 seconds (“Red Book”) to 2. seconds. Space initially destined to the Lead Out is now filled in with data. For this reason, CD-ROMs have not a capability of 74 minutes, but of 77 minutes. As for CDRecordable, the above technique has been named as “Over Burning”, i.e. it is indicated to the CDRecorder, in case its firmware allows it, to write only 2 seconds of Lead Out, following which the multi-session is not certified (the Lead Out would miss the information concerning the next address usable for writing). Obviously, also the space reserved to the Lead In (updated time by time) is lower. As an average, it is possible to obtain an extra data space of about 3 minutes for audio, equivalent to 26 Mbytes of data.

The realisation of the master, which is comprised of two masters, respectively layers A and B, will be described in the following.

Second master is comprised of a standard master (or PCD Perfect Compact Disc) master, if possible), realised by the standard procedures.

The only difference introduced during this step concerns the first 12 bytes of the data blocks, that are modified, putting as offset the running time of the last valid data block of the first layer A Substantially, it can be imagined a disc having a variable ray. If 1,2 Gbyte are introduced, diameter necessary to contain this information is about 16 cm.

Corresponding running time is thus of 629,146 sectors, i.e. 8388 seconds, i.e. about 140 min.

It is known that it is possible to introduce an average of 74 minutes into a CD having a diameter of 12 cm. In this case, the information written on the second layer B must have an addressing of the read block.

This operation can be obtained by software, modifying the ISO image created by every masterisation program, for video and audio data.

As for audio data, usually the encoder already has the functionality to modify the information contained into the “Sub Channel” (bytes sequences corresponding into the first 8 bytes of 6 contiguous blocks).

The master relevant to the layer A must contain a Lead-in, wherein the end of the data track (beginning of the Lead-Out) is declared as starting at about 59 mm, more or less as in the standard cases. Really, the effective data track ends before 59 mm.

As a consequence of this different declaration and realisation of the beginning of the Lead-Out track, multilayer data memory optical storage medium according to the invention is subjected to an “authoring” phase before the masterisation, comprising, among the others, the following sub-phases:

preparation of a fictitious file having a length corresponding to the difference between the end of the data track declared in the Lead-In and the one physically present;

introduction of sand fictitious file into the original data sequence to be masterised, in such a way that it is recorded on the optical storage medium, exactly in the zone where the reader/masteriser losses the focusing, without loosing any datum of the original sequence.

Further, the kind of fictitious file varies according to the kind of original data to be masterised, e.g. it will be comprised of a sequence of black if the original data are of the video kind and/or a sequence lacking sound if the original data are of the audio and/or video kind.

According to the layer, the stamper to be realised is different. In fact, as already said, layer A seems to be much more a standard CD, and thus its stamper is an optical data support, or “media” as “SON” of the “FATHER”.

As for the stamper relevant to the layer B, being it necessary that said layer is inserted al upturned (see FIG. 7), to allow the correct reading the negative of the “SON” must be employed, and consequently the negative of the “FATHER”.

Therefore, stamper for layer B is obtained copying the “SON” starting from the “MOTHER” and not from the “FATHER”, In this way, it is obtained a new kind of stamper that, always using the traditional terminology, could be indicated as “DAUGHTER”.

FIGS. 6 and 7 show the section of layers A and B, respectively.

During the replica, the two layers A and B must be obviously treated differently.

Layer A, that is the lower layer of the optical data storage medium according to the invention, is moulded according to a standard procedure. The only difference is the kind of reflecting material employed, and that, differently with respect to the standard case, is not aluminium, but a semi-reflecting layer comprised of a material chosen from the group of Au, Ag, Al, silicone carbonate (SiC) and silicone.

Preferably, according to the invention, said semi-reflecting material layer is comprised of silicone.

Furthermore, according to the invention, said semi-reflecting material layer has a thickness between 300 and 1000 micron.

To realise the layer A, unlike the traditional technique for CD, the lacquering phase is omitted.

As for layer B, it is moulded as if Low Density layer of a SACD (Super Audio CD, on which a CD layer and a DVD layer are present).

Metalisation is present in layer B, said metalisation being comprised of an aluminium layer, a it occurs in the conventional standards, directly placed on the data layer B.

Lacquering is not present since it is superfluous.

However, to easy the silk printing of the data optical storage medium, it is preferable to put a metalisation layer on the upper layer at 1.8 mm.

Making specific reference to FIG. 8, it is described in greater detail the technique by which the two layers A and B are glued.

Really, technique employed is similar to the one used for DVD9 and SACD.

After having obtained the two layers A and B by injection moulding, layer B is “upturned” of 180° (track on which data are masterised is inverted) and coupled with layer A by a centrifugal gluing technique.

The kind of bonding layer is a silicone-based optically neutral layer, neutral with respect to the specific wavelength, but sensitive to the UV emissions.

A drop of bonding layer is put in correspondence of the inner diameter of layer A that, as already said, is the thicker layer).

Layer B, providing a certain curvature, is place in correspondence of the layer A in such a way that the two respective centres correspond.

The system is quickly rotated and the centrifugal effect uniformly spreads the adhesive on the contact surface, thus creating a kind of suction cup effect, by which mass of layer A draws the mass of layer B, creating an almost perfect adhesion.

The subsequent exposition to UV rays allows to the adhesive to set.

The following steps are standard inspection and moulding steps of the multilayer optical data storage medium obtained.

Apart from the realisation of the multilayer optical data storage medium according to the invention, main problems faced, and that are essential for the realisation and the use of the same optical data storage medium, are two, and particularly the possibility of changing the focus plane, and making the player coming back to the “inner diameter” of the optical data storage medium, starting again to read the data.

As for the problems relevant to the change of the focus plane, it must be distinguished the case of the standard CD player from the DVD and SACD players (they are all players in which it is wished to read the corresponding optical data storage medium according to the invention).

It is known that a standard CD player provides two reference signals that must be always kept within a validity range.

Said signals concern a tracking signal indicating to the reader the fact that it is in a track, and a focusing signal indicating to the reader that its pick-up is set to allow the reading on a given plane which is at a certain distance.

It is also known that between the two signals, the second one is more important, since the condition of lack of focus cannot coexist with the presence of track reading.

In other words, the reading is subordinated to the presence of focalisation.

In a first embodiment according to the invention to obtain the change of focus plane, it has been thought to create a sudden signal interruption, thus interrupting the metalisation, “anticipating” the same with respect to what usually provided.

Said metalisation anticipation is realised by use of suitable masks, having a variable shape according to the shape of the layers comprising the support.

The Lead-Out track is completely lacking in layer A, and it is declared that the data track ends beyond the provided metalisation.

By this kind of solution, during the reading, when the laser reaches the “blank” zone (the part not containing any information), the focus signal is lost, and consequently it is lost the signal track The firmware induces the pick-up to start to oscillate, “searching” the focusing plane lower or above.

Moving upward, pick-up meets the layer B and focuses the reading plane on the same.

To anticipate the metalisation in the wished point, it has been necessary to realise a suitable mask, preferably comprised of copper, to be mounted during the sputtering phase.

Observing FIG. 9, showing the section view of a standard CD, it can be noted that the matalisation covers also the area destined to the Lead-Out track.

It is the presence of this metalisation that allow the beam reflection. Therefore, in case the CD is moulded and not metalised, it would not be possible to read the same.

Consequently, and making reference also to FIG. 10, reading the lower layer, a point would be reached where data and metalisation completely lack. Even if the data would be present, the same result would be obtained, so as noticeable if lacking of the metalisation.

Now, the process followed by the beam is the one already described.

The above procedure, described for the standard CD (for which the reading is an improved PTP), is essentially valid for DVD or SACD. In fact, DVD or SACD player can indifferently read TPT and PTP media, thus in case of TPT, metalisation is anticipated if the medium is read in a clockwise direction (from inside to outside), and is delayed if the reading direction is anticlockwise (from outside to inside).

Bonding layer has no effect on the beam laser. Adhesive used as bonding layer has already been used to realise SuperAudioCD, in which also the Hybrid CD, comprised of a CD layer and of a DVD layer, is included.

As for the second problem, i.e. the one concerning the return of the beam on the inner diameter of the CD, when the pick-up focuses on the layer B the reading of some consecutive blocks occurs, to be sure that this operation is properly completed.

First 16 bytes are used to address the block as min:sec:frame.

In an inner buffer, the device always memorises the condition of the last correctly read block, thus reading a block too close to the outer edge of the second layer, and automatically returns toward the inner diameter, making timed readings to determine the position where it is.

Once intercepted the block to be read, the player starts again to regularly operate.

The modification of the RAW image to create the two masters, can be carried out by software (in this case a RAW writing is considered in the glass-mastering phase), or modifying the data flow from the supply to the glass beam and thus creating suitable extra procedures of the programs used during this phase.

The present invention has been described for illustrative but not limitative purposes, according to its preferred embodiments, but it is to be understood that modifications and/or changes can be introduced by those skilled in the art without departing from the relevant scope as defined in the enclosed claims.

1. Multilayer optical data storage medium, characterised in that it comprises a first layer and a second overturned layer, said first and second layers being coupled each other by the interposition of an optically neutral coupling layer, said first and second layers both defining a focal reading plane, readable by a standard driving system, the data distribution of the data on the focal plane of said first layer being such to provide a zone lacking the data, to which zone corresponds the presence of data on the focal plane of the second layer, in such a way that the player, loosing the focal plane on the first layer individuates the focus signal on the second layer.

2. Multilayer optical data storage medium according to claim 1, characterised in that said first layer is comprised of a standard CD.

3. Multilayer optical data storage medium according to claim 1, characterised in that said first layer is comprised of a standard DVD-9 “No Reverse”.

4. Multilayer optical data storage medium according to claim 1, characterised in that said first layer is comprised of a Super Audio CD (SACD).

5. Multilayer optical data storage medium according to one of the preceding claims, characterised in that said second layer has a reduced thickness with respect to said first layer.

6. Multilayer optical data storage medium according to one of the preceding claims, characterised in that it is Readable or Writable on both layers comprising the medium, or it is Readable on one side and Writable on the other side.

7. Multilayer optical data storage medium according to claim 3, characterised in that the thickness of said first layer varies between 1-1.4 and the thickness of said second layer varies between 0.4 and 0.6 mm.

8. Multilayer optical data storage medium according to claim 3, characterised in that the two layers can have every shape, both having the same shape, of having different shapes.

9. Multilayer optical data storage medium according to one of the preceding claims, characterised in that data on said second layer are printed on a “SON” deriving from the “MOTHER”.

10. Multilayer optical data storage medium according to one of the preceding claims, characterised in that said optically neutral layer is comprised of a layer of optically neutral glue.

11. Multilayer optical data storage medium according to one of the preceding claims, characterised in that said second layer is obtained by a standard master, the first 12 bytes of the data blocks of which are modified inserting the running time of the last valid data block of the first layer as offset.

12. Multilayer optical data storage medium according to one of the preceding claims, characterised in that said first layer is obtained by a master containing a lead-in, wherein the end of the data track is indicated starting from a distance different with respect to where it really ends, particularly an indication of 59 mm.

13. Multilayer optical data storage medium according to one of the preceding claims, characterised in that it is subjected to an “authoring” phase before the masterisation, comprising, among the others, the following sub-phases:
preparation of a fictitious file having a length corresponding to the difference between the end of the data track declared in the Lead-In and the one physically present;
introduction of sand fictitious file into the original data sequence to be masterised, in such a way that it is recorded on the optical storage medium, exactly in the zone where the reader/masteriser losses the focusing, without loosing any datum of the original sequence.

14. Multilayer optical data storage medium according to claim 13, characterised in that the kind of fictitious file varies according to the kind of original data to be masterised.

15. Multilayer optical data storage medium according to claim 13 or 14, characterised in that the kind of fictitious file to be introduced into a video data to be masterised is a sequence of black.

16. Multilayer optical data storage medium according to claim 13, 14 or 15, characterised in that the fictitious file to be introduced into a series of audio data to be masterised is lacking sound sequence.

17. Multilayer optical data storage medium according to one of the preceding claims, characterised in that the stamper for the second layer is realised employing a negative stamper of the “SON”, i.e. the negative of the “FATHER”.

18. Multilayer optical data storage medium according to one of the preceding claims, characterised in that the first layer provides a semi-reflecting layer comprised of a material chosen in the group comprising Au, Ag, Al, silicium carbonate and silicone.

19. Multilayer optical data storage medium according to claim 18, characterised in that the semi-reflecting layer is comprised of silicone.

20. Multilayer optical data storage medium according to claim 18 or 19, characterised in that the semi-reflecting layer has a thickness variable between 300 and 1000 micron.

21. Multilayer optical data storage medium according to one of the preceding claims, characterised in that said second layer provides a metalisation layer comprised of an aluminium layer.

22. Multilayer optical data storage medium according to one of the preceding claims, characterised in that the metalisation on said first layer is interrupted in a point anticipated with respect to what is declared in the lead-in.

23. Multilayer optical data storage medium according to one of the preceding claims, characterised in that the metalisation is interrupted employing suitable masks having variable shape according to the shape of the layers comprising the medium.

24. Multilayer optical data storage medium according to one of the preceding claims, characterised in that one or more chips and/or one or more magnetic strips, and/or contactless reading systems are provided on the upper layer.
